(19) United States
(12) Patent Application Publication
(10) Pub. No.: US 2022/0048084 A1
(43) Pub. Date: Feb. 17, 2022

(54) Composition and Method for Removing and Recovering Hydrocarbons from a Solid Phase

(71) Applicant: Soil Remediation G.P.T. SAGL, Lugano (CH)

(72) Inventors: Gian Furio GUSLANDI, Torino (IT); Luigi TIRRITO, El-Biar (DZ)

(21) Appl. No.: 17/057,052

(22) PCT Filed: May 6, 2020
(86) PCT No.: PCT/IB20/54294

§ 371 Date: Nov. 19, 2020

(30) Foreign Application Priority Data
May 6, 2019 (IT) 102019000006569
Jul. 18, 2019 (IT) 102019000012309

(51) Int. Cl. B09C 1/08; B09C 1/02; C09K 8/584; C10G 1/04; C10G 33/02; C11D 1/83

(52) U.S. Cl. CPC B09C 1/08; B09C 1/02; C11D 1/83; C10G 1/04; C10G 33/02; C09K 8/584

(57) ABSTRACT

A method for removing hydrocarbons from a solid phase and recovery thereof comprising the steps of

washing the solid phase contaminated with hydrocarbons by means of a composition comprising at least a surfactant so as to obtain a clean solid surface and a hydrocarbon-rich aqueous solution,
separating the hydrocarbon-rich aqueous solution from the clean solid phase, and
treating the hydrocarbon-rich aqueous solution by means of electrocoagulation/electroflotation to recover the hydrocarbons.

### CROSS-REFERENCE TO RELATED APPLICATIONS

This patent application claims priority from Italian patent application no. 102019000006569 filed on Jun. 5, 2019 and Italian patent application no. 102019000012309 filed on 18 Jul. 2019, the entire disclosure of which is incorporated herein by reference.

### TECHNICAL FIELD

The present invention concerns a method for removing hydrocarbons from a solid phase, in particular from contaminated soil, and the recovery thereof.

### BACKGROUND ART

The extraction, handling and transport of hydrocarbons often cause contamination of the surface soil where said activities are carried out due to spillages. The concentration of hydrocarbons in this soil or sand can reach very high values, up to hundreds of kilograms per cubic metre of soil, thus requiring remediation in order to restore the soil and bring its parameters back within the limits established by national law. Furthermore, the large quantity of hydrocarbons present in the contaminated soil represents a considerable source of contamination and, at times, also a loss of significant resources.

Various methods are currently known for removing hydrocarbons from soil and sand.

One of these methods entails incineration and desorption in situ. This technique for the remediation of soil and sand involves raising the temperature of the soil until bringing the hydrocarbons to controlled combustion or their transformation into gas. However, this technique does not allow control of the final hydrocarbon concentrations and entails a high environmental cost due to a significant emission of contaminants into the atmosphere during the process and loss of the hydrocarbons.

Another known method is solidification/stabilization/encapsulation. This technique entails the production of a solid mass, which has a sufficiently high structural integrity to allow transport and/or disposal without the need for secondary containment and minimizing dispersion of the contaminants. Stabilization entails the immobilization of hydrocarbons, heavy metals and other constituents of the soil by chemical alteration with a hydraulic binder (for example silicates) to form insoluble compounds or by incorporation in the solidified soil by, for example, covering with concrete. The dry material thus obtained has acceptable parameters for land burial in situ or disposal in an approved facility. This technique uses a large quantity of compounds for stabilization and solidification and makes it impossible to recover the hydrocarbons. Furthermore, in the long term there is the risk of cracking with consequent percolation of the hydrocarbons.

Thermal desorption is the technique most widely used in Algeria, since it allows partial recovery of the hydrocarbons. It entails excavation of the soil or sand, transport of it off site, where it undergoes a thermal process ranging from 250 to 500 degrees centigrade to carry out desorption of the organic part (hydrocarbons) in the form of gas from the inorganic part (soil and sand matrix). The gas hydrocarbons are subsequently purified of dust and other substances, recondensed, and partly recovered. This technique has a high cost due to the transport of large quantities of soil. Furthermore, gases and dust are produced which have to be treated prior to re-introduction into the environment. Also this process is characterized by a significant emission of contaminants into the atmosphere.

Other systems include excavation and washing ex situ of the soil or sand containing the hydrocarbons, a technique that removes the hydrocarbons and other substances from the soil by washing it with a liquid (often with a chemical additive), and then separating the clean soil from the contaminated soil and washing water, a technique that uses large volumes of water and does not allow recovery of the hydrocarbons.

The need is therefore felt in the art for a new method for removing hydrocarbons from a solid surface, in particular contaminated soil, which is without the drawbacks of the known methods.

### DISCLOSURE OF INVENTION

The object of the present invention is therefore to provide a method which is able to remove large quantities of hydrocarbons and allows minimization of the quantity of non-recoverable soil, recycling of the water used, recovery of the hydrocarbons removed and a considerable reduction in costs.

The object of the present invention is achieved by a method for removing and recovering hydrocarbons according to claim 1.

In particular, a method is provided for removing hydrocarbons from a solid phase and the recovery thereof comprising the steps of:

a) washing the solid phase contaminated with hydrocarbons by means of a composition comprising at least a surfactant so as to obtain a clean solid surface and a hydrocarbon-rich aqueous solution;
b) separating the hydrocarbon-rich aqueous solution from the clean solid phase;
c) treating the hydrocarbon-rich aqueous solution by means of electrocoagulation/electroflotation to recover the hydrocarbons.

According to a first embodiment, the composition can comprise:
10 to 20% by weight, based on the total weight of the composition, of an alkylpolyglucoside with an alkyl chain having average length ranging from 6 to 14 carbon atoms;
2 to 10% by weight, based on the total weight of the composition, of a non-ionic surfactant comprising a triglyceride alkoxylated with ethylene oxide and/or propylene oxide and esterified at least partially with a fatty acid with an alkyl chain having 6 to 22 carbon atoms;
0.5 to 6% by weight, based on the total weight of the composition, of an alkylbenzenesulfonate; and water.

In one embodiment, the alkylpolyglucoside is selected from alkylpolyglucosides with an alkyl chain having average length ranging from 10 to 12 carbon atoms such as, for example GLUCOPON GD70. Preferably, the alkylpolyglucoside is present in a quantity ranging from 17 to 19% by weight, based on the total weight of the composition.

The surfactant comprising an alkoxylated triglyceride is a product obtained by alkoxylation of triglycerides, esterified wholly or partly with fatty acids having 6-22 carbon atoms in which 2 to 40 moles of alkoxylating agent per mole of triglyceride are used. Castor oil and/or castor oil dehydrated with ethylene oxide, partially esterified with oleic acid, such as MARLOWET LVS, are preferably used.

Preferably, said compounds are present in a quantity ranging from 5 to 7% by weight, based on the total weight of the composition.

The alkylbenzenesulfonate is preferably linear and is even more preferably sodium dodecylbenzenesulfonate, for example MARLON A350.

In an alternative embodiment, the composition can comprise:
20 to 35% by weight, based on the total weight of the composition, of an anionic surfactant selected from the group consisting of alkoxylated fatty acid sulfates and alkoxylated fatty acid ether sulfates;
0.5 to 8% by weight, based on the total weight of the composition, of an alkoxylated alcohol;
0.5 to 8% by weight, based on the total weight of the composition, of a propoxylated ethoxylated alcohol; and water.

In one embodiment, the alkoxylated fatty acid sulfates and the alkoxylated fatty acid ether sulfates are selected from compounds obtained from fatty acids having 8 and 20 carbon atoms, preferably 10-16 carbon atoms, alkoxylated or non-alkoxylated, preferably ethoxylated with 1-5 moles of ethylene oxide. Even more preferably the anionic surfactant is sodium lauryl ethersulfate.

Preferably, said compounds are present in a quantity ranging from 25 to 30% by weight, based on the total weight of the composition.

In one embodiment, the alkoxylated alcohol is an alcohol having 8 to 20 carbon atoms, preferably 9 to 11, and alkoxylated with 1-8 moles of ethylene oxide.

In one embodiment, the propoxylated ethoxylated alcohol is an alcohol having 8 to 20 carbon atoms, preferably 10 to 16.

The composition of the invention can further comprise an organic solvent, a chelating agent and a suspending agent.

The organic solvent, when present, is present in a quantity of up to 5% by weight, based on the total weight of the composition, and is preferably selected from the group consisting of isopropanol and ethanol.

The chelating agent, for example glutamic acid tetrasodium salt, N,N diacetic acid, is present in a quantity up to 1% by weight, based on the total weight of the composition.

The suspending agent, preferably a silicate, more preferably sodium metasilicate, is present up to 3% by weight, based on the total weight of the composition.

### BRIEF DESCRIPTION OF THE DRAWING

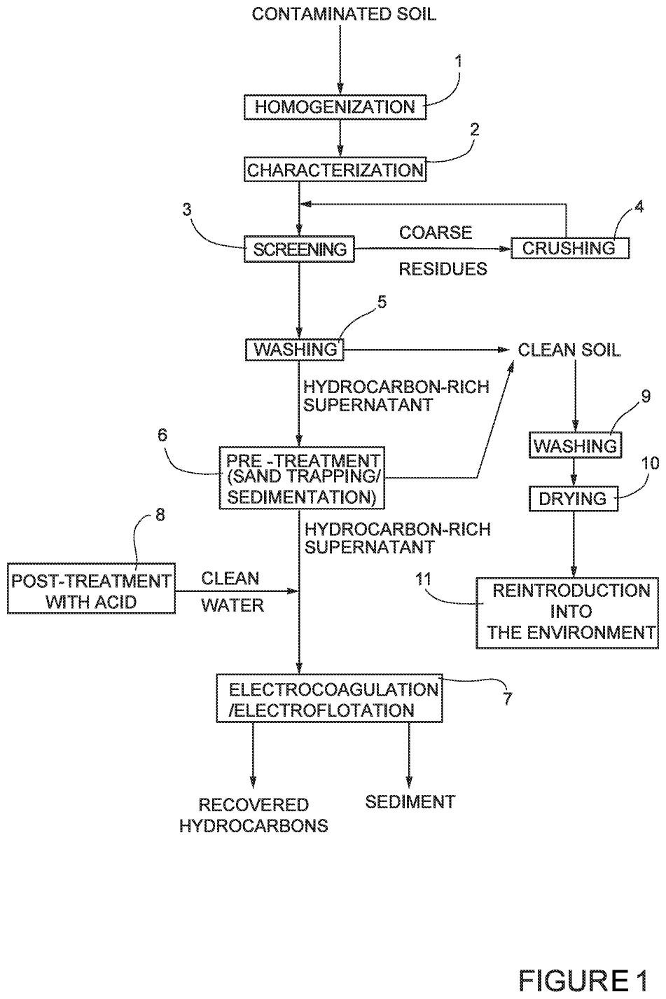

The method for removal of the hydrocarbons from a solid phase and the recovery thereof according to the present invention will now be described in detail with reference to the figures of the attached drawings, which show purely illustrative and non-limiting embodiment examples, in which FIG. 1 illustrates a schematic representation of an embodiment of the method of the present invention.

Advantageously, the method of the invention allows the recovery of hydrocarbons with alkyl chains containing mainly 5 to 40 carbon atoms, but also hydrocarbons with longer chain from soil contaminated also by bentonites and polymers.

### BEST MODE FOR CARRYING OUT THE INVENTION

The method shown in FIG. 1 refers to the process for removing hydrocarbons from contaminated soil, for example sand, taken near plants for the extraction and refinement of hydrocarbons or along hydrocarbon distribution and transport lines.

Before being processed to remove the hydrocarbons, the soil taken from the extraction site can be mechanically mixed, if necessary, so as to obtain a uniform product (step 1).

The sample can be further analysed to obtain a characterization thereof so as to optimize the process parameters for removal of the hydrocarbons (step 2).

Optionally, the sample is screened (step 3). The fragments with larger dimensions than those of the screen meshes are furthermore crushed so as to increase the surface area of the soil sample to be treated (step 4). The crushed sample is re-sent to the screening step.

At this point, the pre-treated soil sample undergoes the process for removal of the hydrocarbons according to the invention.

In particular, the contaminated soil is mixed in a tank with water and a solution comprising:
10 to 20% by weight, based on the total weight of the composition, of an alkylpolyglucoside with an alkyl chain having average length between 6 and 14 carbon atoms;
2 to 10% by weight, based on the total weight of the composition, of a surfactant comprising a triglyceride alkoxylated with ethylene oxide and/or propylene oxide and esterified at least partially with a fatty acid with alkyl chain having 6 to 22 carbon atoms;
0.5 to 6% by weight, based on the total weight of the composition, of an alkylbenzenesulfonate; and water.

For example, the composition consists of the following:

TABLE 1

| Quantity (% by | | |
|---|---|---|
| weight, based on | | |
| the total weight | | |
| of the | | |
| composition) | Trade name/Category | Function |
| 0.50 | Sodium metasilicate | Suspending |
| | (silicate) | agent |
| 0.01 | Dissolvine FL38 | Chelating |
| | (Glutamic acid, | agent |
| | diacetic acid, | |
| | tetrasodium salt) | |
| 18 | Glucopon GD70 | Non-ionic |
| | (alkylpolyglucoside) | surfactant |
| 6 | Marlowet LVS | Non-ionic |
| | (Polyethoxylated castor | surfactant |
| | oil esters) | |
| 2 | Marlon A350 (Sodium | |
| | dodecylbenzenesulfonate) | |
| 3 | Isopropanol | Solvent |
| 70.49 | Water | Solvent |

For every cubic metre of soil treated, approximately 1.4 cubic metres of water and 7 to 13 litres of the composition of table 1 are added.

The mixture thus obtained is mechanically agitated to facilitate washing (step 5) of the soil and passage of the hydrocarbons to the aqueous phase to form a suspension. Preferably, said process is carried out using water at a temperature ranging from 30 to 60° C., more preferably at a temperature of 45° C.

The solid phase consisting of the clean soil is then left to sediment and the supernatant, consisting of a hydrocarbon-rich aqueous suspension, is collected.

The results obtained with the composition of table 1 subjecting a soil sample to the washing step only (step 5) are reported in table 2.

TABLE 2

| | Hydrocarbon | Removal |
|---|---|---|
| Sample | concentration | percentage |
| Sample 1 before | 5516 ppm | |
| washing | | |
| Sample 1 after | 1500 ppm | 72.8% |
| washing | | |
| Sample 2 before | 9000 ppm | |
| washing | | |
| Sample 2 after | 3500 ppm | 62.4% |
| washing | | |
| Sample 3 before | 3600 ppm | |
| washing | | |
| Sample 3 after | 802 ppm | 77.7% |
| washing | | |

The clean soil can therefore be washed with water (step 9) and dried (step 10) before reintroduction into the environment (step 11).

The supernatant of step 5 composed of the hydrocarbon-rich aqueous suspension is then treated to separate and recover the hydrocarbons and the water for possible re-use thereof.

In particular, the supernatant of step 5 is treated by means of electrocoagulation/electroflotation (step 7) so as to eliminate the solids still present in suspension and to separate the water and the hydrocarbons. Before said step 7, the supernatant of step 5 can be optionally pre-treated by allowing the solid phase contained in it, consisting of clean soil, to further sediment; said soil is then recovered and reintroduced into the environment.

Electrocoagulation/electroflotation is a technique that allows the separation of a hydrocarbon suspended in an aqueous solution by the application of an electric current. The application of an electric current by means of electrodes immersed in the suspension generates, by electrolytic oxidation of the anode, ions which act as a coagulant.

In particular, in the case of an anode made of aluminium, the following reactions occur when the electric current is applied:

Al(0)->Al³⁺+3e⁻

H₂O+2e⁻->2OH⁻+H₂(gas)

Al³⁺+3OH⁻->Al(OH)₃(solid)

In this case, the gaseous hydrogen that develops facilitates flotation of the hydrocarbons towards the surface of the suspension. The aluminium hydroxide, on the other hand, precipitates and, if necessary, with the aid of a flocculating polymer such as polyacrylamide or polydiallyldimethylammonium chloride (PDADMAC), facilitates precipitation of the suspended solids.

Preferably, step 7 of electrocoagulation/electroflotation is conducted at a slightly basic pH, for example 7.5, obtained by the addition of a base, for example sodium or calcium hydroxide.

The end of step 7 results in re-usable hydrocarbons, a sediment and water that can be re-used, by means of recirculation, both in the process of the invention, for example in step 5 of washing the contaminated soil or in step 9 of washing the clean soil, and, for example, for agricultural use.

Optionally, it is possible to treat the water, prior to re-introduction into the environment, with an acid (step 8), for example hydrochloric acid or sulphuric acid, to neutralize the pH after addition of the base in the electrocoagulation step 7.

In terms of yield, for each cubic metre of contaminated soil treated, with an initial water consumption of 1.4 m³, the method of the invention allows 0.9 m³ of clean soil and 0.8 m³ of re-usable water to be recovered. 60 to 80% of hydrocarbons present in the contaminated soil are also recovered.

In one alternative embodiment, after screening, the contaminated soil is mixed in a tank with water and a solution comprising:
20 to 35% by weight, based on the total weight of the composition, of an anionic surfactant selected from the group consisting of alkoxylated fatty acid sulfates and alkoxylated fatty acid ether sulfates;
0.5 to 8% by weight, based on the total weight of the composition, of an alkoxylated alcohol;
0.5 to 8% by weight, based on the total weight of the composition, of a propoxylated ethoxylated alcohol; and water.

For example, the composition consists of the following (table 3):

TABLE 3

| Quantity (% by | | |
|---|---|---|
| weight, based on | | |
| the total weight | | |
| of the | | |
| composition) | Trade name/Category | Function |
| 25 | Lauryl ethersulfate | Anionic |
| | | surfactant |
| 3 | C9-11 ethoxylated | Surfactant |
| | alcohol (4 moles | |
| | ethylene oxide) | |
| 2 | C10-16 propoxylated | Surfactant |
| | ethoxylated alcohol | |
| 70 | Water | |

For each cubic metre of soil treated, approximately 1.4 cubic metres of water and 5 to 13 litres of the composition of table 3 are added.

The mixture thus obtained is treated as described above.

The results obtained by subjecting a soil sample to the washing step only (step 5) are shown in table 4.

TABLE 4

| | Hydrocarbon | Removal |
|---|---|---|
| Sample | concentration | percentage |
| Sample 1 before | 15520 ppm | |
| washing | | |
| Sample 1 after | 1023 ppm | 93.4% |
| washing | | |
| Sample 2 before | 9000 ppm | |
| washing | | |
| Sample 2 after | 750 ppm | 91.7% |
| washing | | |
| Sample 3before | 13600 ppm | |
| washing | | |
| Sample 3 after | 880 ppm | 93.5% |
| washing | | |

The clean soil can therefore be washed with water (step 9) and dried (step 10) before being reintroduced into the environment (step 11).

The supernatant of step 5 consisting of the hydrocarbon-rich aqueous suspension can then be treated to separate and recover the hydrocarbons and the water for possible re-use by means of electrocoagulation/electroflotation (step 7) as described above.

The yields are as follows: for each cubic metre of contaminated soil treated, with an initial water consumption of 1.4 m³, the method of the invention allows the recovery of approximately 0.95 m³ of clean soil and 1.25 m³ of re-usable water. 80 to 90% of hydrocarbons present in the contaminated soil are also recovered.

Advantageously, therefore, the method for removing and recycling hydrocarbons and process water according to the invention allows rapid remediation of the soil directly in situ, entails low water consumption (85 to 95% of the water initially used for the process is recovered) and a high productivity, and does not involve the production of toxic gases.

1. A method for removing hydrocarbons from a solid phase and recovery thereof comprising the steps of:
a) washing the solid phase contaminated with hydrocarbons by means of a composition comprising at least a surfactant so as to obtain a clean solid phase and a hydrocarbon-rich aqueous solution;
b) separating the hydrocarbon-rich aqueous solution from the clean solid phase; and
c) treating the hydrocarbon-rich aqueous solution by means of electrocoagulation/electroflotation to recover the hydrocarbons.

2. The method according to claim 1, characterized in that it comprises, after step b), a step c1) of allowing solid matter remaining in the hydrocarbon-rich aqueous solution to further sediment and separating the hydrocarbon-rich aqueous solution from the sediment.

3. The method according to claim 1, characterized in that said solid phase is a soil contaminated by hydrocarbons.

4. The method according to claim 1, characterized in that said surfactant is selected from the group of anionic surfactants and non-ionic surfactants.

5. The method according to claim 1, characterized in that said composition comprises:
10 to 20% by weight, based on the total weight of the composition, of an alkylpolyglucoside with an alkyl chain having average length between 6 and 14 carbon atoms;
2 to 10% by weight, based on the total weight of the composition, of a non-ionic surfactant comprising a triglyceride alkoxylated with ethylene oxide and/or propylene oxide and esterified at least partially with a fatty acid with an alkyl chain having 6 to 22 carbon atoms; and
0.5 to 6% by weight, based on the total weight of the composition, of an alkylbenzenesulfonate; and water.

6. The method according to claim 1, characterized in that said composition comprises:
20 to 35% by weight, based on the total weight of the composition, of an anionic surfactant selected from the group consisting of alkoxylated fatty acid sulfates and alkoxylated fatty acid ether sulfates;
0.5 to 8% by weight, based on the total weight of the composition, of an alkoxylated alcohol;
0.5 to 8% by weight, based on the total weight of the composition, of a propoxylated ethoxylated alcohol; and water.

7. The method according to claim 6, characterized in that said composition further comprises up to 1% by weight, based on the total weight of the composition, of a chelating agent.

8. The method according to claim 6, characterized in that said composition further comprises up to 5% by weight, based on the total weight of the composition, of an organic solvent.

9. The method according to claim 8, characterized in that said organic solvent is selected from the group consisting of isopropanol and ethanol.

10. The method according to claim 6, characterized in that said composition further comprises up to 3% by weight, based on the total weight of the composition, of a suspending agent.

11. The method according to claim 5, characterized in that said composition further comprises up to 1% by weight, based on the total weight of the composition, of a chelating agent.

12. The method according to claim 5, characterized in that said composition further comprises up to 5% by weight, based on the total weight of the composition, of an organic solvent.

13. The method according to claim 12, characterized in that said organic solvent is selected from the group consisting of isopropanol and ethanol.

14. The method according to claim 5, characterized in that said composition further comprises up to 3% by weight, based on the total weight of the composition, of a suspending agent.

15. The method of claim 1 wherein said solid phase is a soil contaminated by hydrocarbons and further including the step of selecting said surfactant from the group of anionic surfactants and non-ionic surfactants.

16. The method for removing hydrocarbons from soil and recovering the hydrocarbons comprising the steps of:
a) washing the soil with a composition comprising—
an anionic or non-ionic surfactant;
a chelating agent;
a suspending agent; and
a solvent;
so as to obtain a clean solid phase and a hydrocarbon-rich aqueous solution;
b) separating the hydrocarbon-rich aqueous solution from the clean solid phase;
c) treating the hydrocarbon-rich aqueous solution by means of electrocoagulation/electroflotation to recover the hydrocarbons.

17. The method of claim 16 wherein the chelating agent is glutamic acid tetrasodium salt, N,N diacetic acid.

18. The method of claim 16 wherein the suspending agent is sodium metasilicate.

19. The method of claim 16 wherein the solvent is either isopropanol or ethanol.
